(19) United States
(12) Patent Application Publication
(10) Pub. No.: US 2009/0284076 A1
(43) Pub. Date: Nov. 19, 2009

(54) FAULT-TOLERANT BATTERY SET AND START-UP BATTERY MODULE

(75) Inventors: Wen-Hen LIN, Wujie Township (TW); Keh-Chi TSAI, Saratoga, CA (US); Yuan-Chi HSU, Banciao City (TW); Peng-Hung YU, Banciao City (TW)

Correspondence Address: Workman Nydegger;1000 Eagle Gate Tower, 60 East South Temple, Salt Lake City, UT, 84111, US

(73) Assignees: APOGEE POWER, INC., Campbell, CA (US); NATIONAL ENERGY TECHNOLOGY CO., LTD., Tucheng City (TW)

(21) Appl. No.: 12/176,845

(22) Filed: Jul. 21, 2008

(30) Foreign Application Priority Data
May 16, 2008 (TW) 097118248

(51) Int. Cl. H02J 9/00; H02M 3/06

(52) U.S. Cl. 307/66; 307/109

(57) ABSTRACT

A fault-tolerant battery set and a start-up battery module are described. The fault-tolerant battery set includes a main battery module, a battery monitoring unit, a control switch unit, and a back-up battery module. The main battery module includes a battery unit and a battery monitoring circuit. When the battery unit fails, the control switch unit conducts a power supply connection path according to a failure signal sent from the battery monitoring circuit, so as to replace the failed main battery module with a back-up power provided by the back-up battery module through the power supply connection path.

### CROSS-REFERENCE TO RELATED APPLICATIONS

This non-provisional application claims priority under 35 U.S.C. §119(a) on Patent Application No(s). 097118248 filed in Taiwan, R.O.C. on May 16, 2008 the entire contents of which are hereby incorporated by reference.

### BACKGROUND OF THE INVENTION

1. Field of Invention

The present invention relates to a battery system and module, and more particularly to a fault-tolerant battery set and a start-up battery module.

2. Related Art

Batteries in various types can be classified in terms of power generation principle, the ability of being recharged for use, the shape, size, configuration, the types of electrolytes adopted, the retention and supply manners of the electrolytes, the voltage, capacitance, and so on. The batteries are basically divided into primary batteries and secondary batteries according to their ability of being recharged for use when running out of the electric energy. The power generation principle of a secondary battery is to convert the chemical energy inside the active substances into the electric energy through an electrochemical oxidation-reduction reaction, and the chemical reaction within the battery is reversible. In brief, a reverse direct current is applied to charge the battery running out of the electric energy, so as to recover the capacitance. The reusable battery is called a secondary battery, i.e., a so-called rechargeable battery.

Among the existing secondary batteries, as the lead-acid battery and the nickel-cadmium battery both have the problem of heavy metal pollution when used up and discarded, they certainly will be wiped out of the market in the future under the rising environmental awareness. Further, during repeated charging and discharging processes, the electrode surface of the lithium battery may easily generate acicular structures, and the acicular structures may pierce the electrolyte and the isolation layer to cause a short circuit, so the lithium battery will fade out of the market due to safety considerations.

The nickel-metal-hydride (NiMH) battery and the lithium-ion battery are high in energy density and cost although they do not have the severe memory effect as the nickel-cadmium battery. The lithium-ion battery provides a working voltage about three times of that of other secondary batteries and is thus widely utilized. Therefore, in addition to the NiMH battery, the lithium-ion battery has been developed more actively in the fields of industry and academy during the recent years.

The electric power storage system for cars, locomotives, or electric generators still relies on the lead-acid battery and the NiMH battery, and certainly will be weeded out by the market in the future under the rising environmental awareness. Therefore, how to provide a battery module both satisfying the safety considerations and the environmental protection demands has become one of the problems to be solved by researchers.

Moreover, in the electric power storage system for cars, locomotives, or electric generators, taking the electric generator for example, in order to meet the power specification required for starting the electric generator, a circuit architecture of batteries in series and parallel is usually adopted to provide the required voltage and current. However, the failure of one of the batteries in the series loop may influence the output voltage and current in the entire series loop and cause the electric generator unable to be normally started or operate. Therefore, how to provide a battery system with high reliability has become another problem to be solved by researchers.

### SUMMARY OF THE INVENTION

Accordingly, in order to solve the above problems, the present invention is mainly directed to a fault-tolerant battery set and a start-up battery module, so as to provide a battery module satisfying safety considerations and environmental protection demands through a circuit architecture constituted by a Li-ion battery and a super capacitor, and also provide a power supply loop switching mechanism to achieve a battery system with high reliability.

Therefore, a fault-tolerant battery set including a main battery module, a battery monitoring unit, a control switch unit, and a back-up battery module is provided. The main battery module, used for providing a main power, includes a battery unit for storing a power and providing the main power, and a battery monitoring circuit electrically connected to the battery unit for monitoring an operating status of the battery unit and sending a failure signal when detecting the battery unit fails. The battery monitoring unit is electrically connected to the main battery module, for collecting the failure signal sent from the battery monitoring circuit and generating a control signal. The control switch unit is electrically connected to the battery monitoring unit and the main battery module, respectively. The back-up battery module is electrically connected to the control switch unit, for providing a back-up power. The control switch unit conducts a power supply connection path according to the control signal, so as to replace the failed main battery module with the back-up power provided by the back-up battery module through the power supply connection path.

Further, a start-up battery module for providing a power required to start an electric generator is also provided. The start-up battery module includes at least one Li-ion battery, at least one protection circuit module, and at least one super capacitor. The Li-ion battery is characterized in being rechargeable, for providing a discharge current. The protection circuit module is serially-connected to the Li-ion battery to form a series group, so as to prevent the Li-ion battery from being damaged. The super capacitor is electrically connected to the Li-ion battery and the electric generator, for receiving and amplifying the discharge current to the electric generator, so as to meet the power required for starting the electric generator.

As for the provided fault-tolerant battery set and start-up battery module, the Li-ion battery is characterized in being small in volume, light in weight, causing no explosion, no fire, no combustion, having a long circulation service life, and allowing large current charge/discharge, etc., and the Li-ion battery is combined with the super capacitor to form the start-up battery module so as to meet the power specification required for starting the electric generator. In addition, under the power supply loop switching mechanism, when the main battery module in the battery system fails, the back-up battery module works as a substitute for supplying power, so as to enable the battery system to continue its normal operation, thereby enhancing the reliability of the battery system.

### BRIEF DESCRIPTION OF THE DRAWINGS

The present invention will become more fully understood from the detailed description given herein below for illustration only, and thus are not limitative of the present invention, and wherein:

FIG. 1A is a schematic block view illustrating the circuit of a start-up battery module according to a first embodiment of the present invention;

FIG. 1B is a schematic block view illustrating the circuit of a start-up battery module according to a second embodiment of the present invention; and

FIG. 2 is a schematic block view illustrating the circuit of a fault-tolerant battery set according to the present invention.

### DETAILED DESCRIPTION OF THE INVENTION

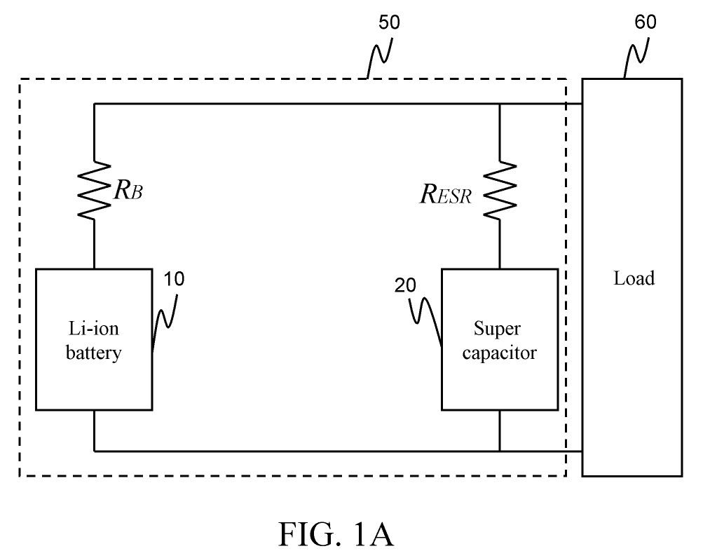

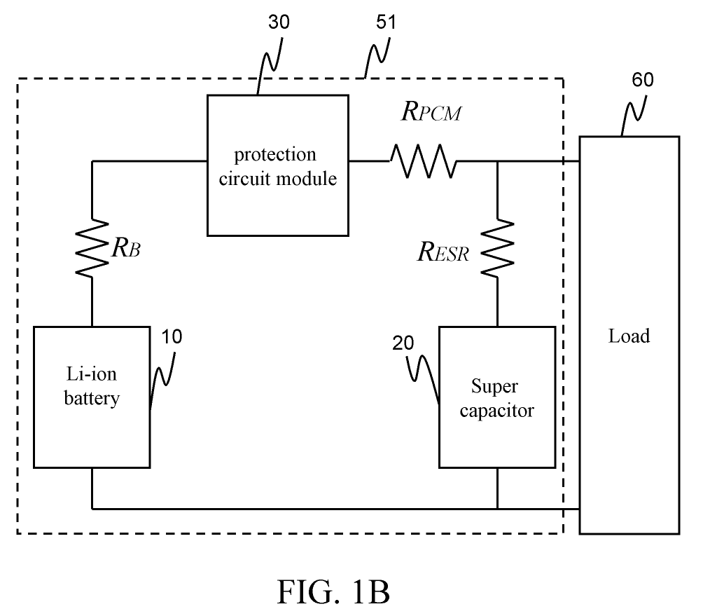

FIG. 1A is a schematic view illustrating the circuit of a start-up battery module according to a first embodiment of the present invention. As shown in FIG. 1A, the start-up battery module 50 of the present invention includes a Li-ion battery 10, a battery internal resistor R_{B}, a super capacitor 20, and an equivalent series resistor (ESR) R_{ESR} of the super capacitor 20. The start-up battery module 50 is connected in parallel to a load 60 for providing a power thereto.

The Li-ion battery 10 is characterized in being rechargeable and used for providing a discharge current. In the Li-ion battery 10, the Li-ion is adopted to form a positive electrode. Due to its advantages in being small in volume, light in weight, causing no explosion, no fire, no combustion, having a long circulation service life, and allowing large current charge/discharge, etc., the Li-ion battery 10 has gradually replaced the lead-acid, NiMH, nickel-cadmium, lithium cobalt, and lithium manganese batteries in recent years. In addition, a series, parallel, or serial-parallel power supply loop can be formed by a plurality of Li-ion batteries 10, so as to meet the voltage or current specification required by the load 60. The Li-ion battery 10 is composed of at least one chemical compounds. The chemical compound can be lithium ion phosphate (LiFePO₄), Li(Ni_{0.5}Mn_{0.5})₁₋ₓCoₓO₂, Li(MnₓCo₁₋ₓ)O₂, Li-beta spinal Mn₂O₄, wherein 1≧x≧0.

The super capacitor 20 and the Li-ion battery 10 are electrically connected in parallel. The super capacitor 20 receives and amplifies the discharge current of the Li-ion battery 10, and then provides the amplified discharge current for the load 60. The super capacitor 20 may be, for example, a metal-ceramic ruthenium-oxide super capacitor, a platinum-based super capacitor, or a gold-based super capacitor. These types of super capacitors have characteristics such as low impedance and rapid reflection of pulse rise time, so as to effectively reduce the overall impedance of the start-up battery module 50 and shorten the pulse rise time, thus increasing the power released instantaneously by the start-up battery module 50.

The load 60 and the start-up battery module 50 are electrically connected in parallel. The load 60 may be, for example, an electric generator, a motor, or an electronic device (such as a digital electronic device or an analog electronic device). The digital electronic device is, for example, a mobile phone, a personal digital assistant (PDA), or a digital camera, and the analog electronic device is, for example, a motor-driven tool or a remote control device like a remote control airplane. In addition, when the load 60 is an analog electronic device of a motor-driven tool, a high peak current is demanded in order to drive the motor, so the super capacitor 20 can be used to transfer the burden from the Li-ion battery 10 to the super capacitor 20 itself Moreover, the super capacitor 20 reflects a pulse rise time less than 5 microseconds to meet the power required for starting the electric generator.

Further, the Li-ion battery 10 and the super capacitor 20 are supplementary to each other. In the start-up battery module 50, the super capacitor 20 not only functions to reduce the overall impedance R of the start-up battery module 50, but also provides a peak current for the load 60, so as to solve the disadvantage that the Li-ion battery 10 fails to generate an instantaneous high power. The Li-ion battery 10 is used to charge and activate the super capacitor 20.

FIG. 1B is a schematic view illustrating the circuit of a start-up battery module according to a second embodiment of the present invention. As shown in FIG. 1B, the start-up battery module 51 of the present invention includes a Li-ion battery 10, a battery internal resistor R_{B}, a protection circuit module 30, an internal resistor R_{PCM} of the protection circuit module 30, a super capacitor 20, and an ESR R_{ESR} of the super capacitor 20. The start-up battery module 51 is connected in parallel to a load 60 to provide a power for the load 60. As the difference between the second and the first embodiment of the present invention lies in the protection circuit module 30, the protection circuit module 30 will be illustrated only below, and the other modules or elements will not be described herein again.

The protection circuit module 30 is serially-connected between the Li-ion battery 10 and the super capacitor 20. A series circuit group is formed by connecting in series the protection circuit module 30 with the Li-ion battery 10 and the battery internal resistor R_{B}. The protection circuit module 30 is used to control a cut-off voltage and an impact current during the charge/discharge, so as to prevent an over-high voltage or current from damaging the load 60 and avoid a short circuit as well as damages to the battery core of the lithium-ion battery or lithium-polymer battery, thus protecting the circuit.

Then, the necessity of the super capacitor 20 and the ESR R_{ESR} is viewed from another aspect. Generally, an overall impedance R of the start-up battery module 51 must remain between 55 mΩ and 70 mΩ. If the start-up battery module 51 includes the protection circuit module 30 and the internal resistor R_{PCM} thereof, but does not have the super capacitor 20 or the ESR R_{ESR} thereof, the impedance R_{B}+R_{PCM} formed by the start-up battery module 51 is between approximately 150 mΩ and 200 mΩ. Therefore, the method for eliminating the excessively large resistance value is nothing but trying to reduce the battery internal resistor R_{B} or connecting in parallel with another resistor. The former lies in the configuration of the Li-ion battery 10 itself and is difficult to perform on the technical level; while in the latter, a serial-parallel circuit group formed by the super capacitor 20 and the ESR R_{ESR} may be adopted to reduce the overall impedance R of the start-up battery module 51 by means of parallel connection. Reference to the following Equation (1):

$$R = \frac{( {R}_{B} + {R}_{PCM} ) \times {R}_{ESR}}{{R}_{B} + {R}_{PCM} + {R}_{ESR}} \leq {R}_{ESR} \qquad ( 1 )$$

As shown in Equation (1), the overall impedance R is smaller than or equal to the ESR R_{ESR}. If the ESR R_{ESR} is seen as a variable, the value of the impedance R is determined by the ESR R_{ESR}. The ESR R_{ESR} may be assigned with a value according to the demand of the load 60 for a specific power, and in general, a typical value is in a range of 50 mΩ to 150 mΩ.

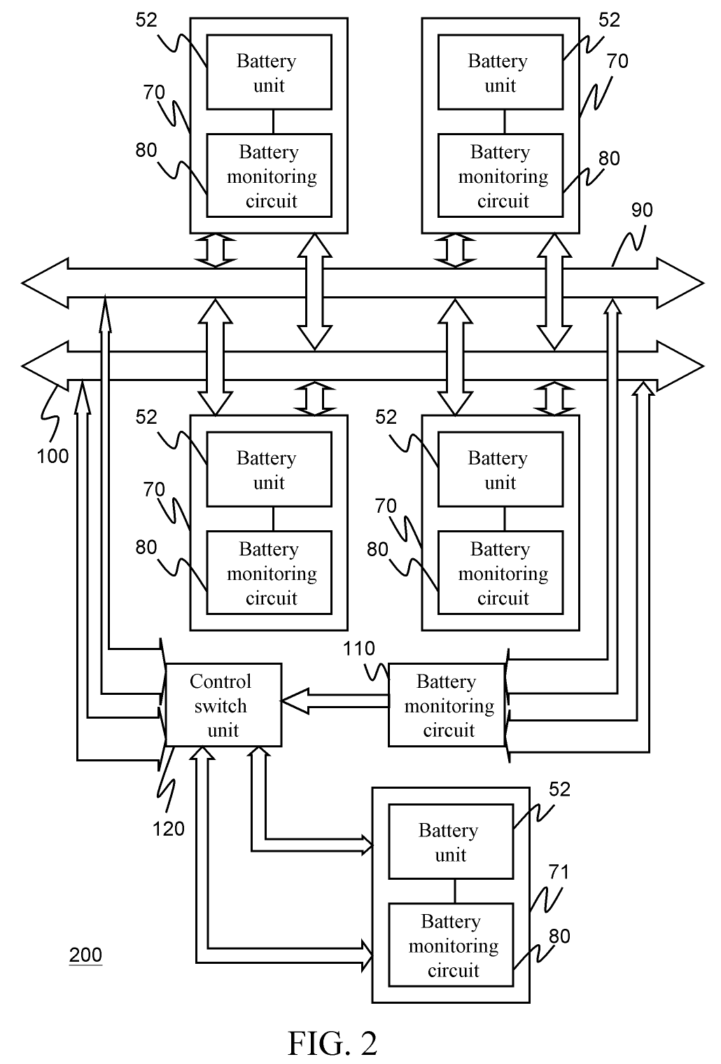

FIG. 2 is a schematic block view illustrating the circuit of a fault-tolerant battery set according to the present invention. As shown in FIG. 2, the fault-tolerant battery set 200 of the present invention includes main battery modules 70, a signal bus 90, a power bus 100, a battery monitoring unit 110, a control switch unit 120, and a back-up battery module 71.

The main battery module 70 is used for providing a main power. Each main battery module 70 includes a battery unit 52 and a battery monitoring circuit 80.

The battery unit 52 is disposed in the main battery module 70, for storing a power and providing the main power. A circuit architecture of the battery unit 52 may be, for example, the start-up battery module 50 in the first embodiment or the start-up battery module 51 in the second embodiment.

The battery monitoring circuit 80 is electrically connected to the battery unit 52, for monitoring an operating status of the battery unit 52 and sending a failure signal when detecting the battery unit 52 fails. The battery monitoring circuit 80 determines whether the battery unit 52 fails or not by, for example, detecting whether an output voltage value or current value of the battery unit 52 is zero or abnormal compared with an output voltage value or current value of other battery units 52.

The signal bus 90 is electrically connected to each of the main battery modules 70, and serves as a medium for signal transmission. The signal bus 90 may be, for example, an inter-integrated circuit bus or a system management bus.

The power bus 100 is electrically connected to each of the main battery modules 70, and serves as a medium for voltage and current transfer.

The battery monitoring unit 110 is electrically connected to the main battery modules 70 via the signal bus 90 and the power bus 100, for collecting the failure signal sent from each battery monitoring circuit 80 and correspondingly generating a control signal. The battery monitoring unit 110 records the failure information (for example, the position, serial number, capacity, or the type of the power supply loop of the battery unit 52) in each main battery module 70 to serve as the reference information for maintenance.

The control switch unit 120 is electrically connected to the battery monitoring unit 110, and further electrically connected to the main battery modules 70 via the signal bus 90 and the power bus 100. The control switch unit 120 has multiple switching loops. The control switch unit 120 may be, for example, a multiplexer.

The back-up battery module 71 is electrically connected to the control switch unit 120, for providing a back-up power. Similarly, the back-up battery module 71 includes a battery unit 52 and a battery monitoring circuit 80. The control switch unit 120 conducts an internal power supply connection path according to the received control signal, so as to replace the failed main battery module 70 with the back-up power provided by the back-up battery module 71 through the power supply connection path. In addition, the number of the back-up battery module 71 in the fault-tolerant battery set 200 may vary upon requirements.

In view of the above, as for the provided fault-tolerant battery set and start-up battery module, the Li-ion battery is characterized in being small in volume, light in weight, causing no explosion, no fire, no combustion, having a long circulation service life, and allowing large current charge/discharge, etc., and the Li-ion battery is combined with the super capacitor to form the start-up battery module so as to meet the power specification required for starting the electric generator. In addition, under the power supply loop switching mechanism, when the main battery module in the battery system fails, the back-up battery module works as a substitute for supplying power, so as to enable the battery system to continue its normal operation, thereby enhancing the reliability of the battery system.

What is claimed is:

1. A fault-tolerant battery set, comprising:
a main battery module, for providing a main power, the main battery module comprising:
a battery unit, for storing a power and providing the main power; and
a battery monitoring circuit, electrically connected to the battery unit, for monitoring an operating status of the battery unit and sending a failure signal when detecting the battery unit fails;
a battery monitoring unit, electrically connected to the main battery module, for collecting the failure signal sent from the battery monitoring circuit and generating a control signal;
a control switch unit, electrically connected to the battery monitoring unit and the main battery module, respectively; and
a back-up battery module, electrically connected to the control switch unit, for providing a back-up power;
wherein the control switch unit conducts a power supply connection path according to the control signal, so as to replace the failed main battery module with the back-up power provided by the back-up battery module through the power supply connection path.

2. The fault-tolerant battery set according to claim 1, wherein the battery unit comprises:
a Li-ion battery, characterized in being rechargeable, for providing a discharge current; and
a super capacitor, electrically connected to the Li-ion battery, for receiving and amplifying the discharge current, so as to form the main power.

3. The fault-tolerant battery set according to claim 2, wherein the Li-ion battery comprising lithium iron phosphate (LiFePO₄).

4. The fault-tolerant battery set according to claim 2, wherein the Li-ion battery comprising Li(Ni_{0.5}Mn_{0.5})₁₋ₓCoₓO₂, 1≧x≧0.

5. The fault-tolerant battery set according to claim 2, wherein the Li-ion battery comprising Li(MnₓCo₁₋ₓ)O₂, 1≧x≧0.

6. The fault-tolerant battery set according to claim 2, wherein the Li-ion battery consist of Li-beta spinal Mn₂O₄.

7. The fault-tolerant battery set according to claim 2, wherein the battery unit further comprises at least one protection circuit module, serially-connected to the Li-ion battery to form a series group, so as to prevent the Li-ion battery from being damaged.

8. The fault-tolerant battery set according to claim 2, wherein the super capacitor reflects a pulse rise time less than 5 microseconds to meet the power required for starting an electric generator.

9. The fault-tolerant battery set according to claim 2, wherein the super capacitor is at least one metal-ceramic ruthenium-oxide super capacitor.

10. The fault-tolerant battery set according to claim 2, wherein the super capacitor is at least one platinum-based super capacitor.

11. The fault-tolerant battery set according to claim 2, wherein the super capacitor is at least one gold-based super capacitor.

12. The fault-tolerant battery set according to claim 1, wherein the main battery module is electrically connected to the battery monitoring unit via a signal bus and a power bus.

13. The fault-tolerant battery set according to claim 12, wherein the signal bus is an inter-integrated circuit bus or a system management bus.

14. A start-up battery module, for providing a power required to start an electric generator, the start-up battery module comprising:
at least one Li-ion battery, characterized in being rechargeable, for providing a discharge current; and
at least one super capacitor, electrically connected to the Li-ion battery and the electric generator, for receiving and amplifying the discharge current to the electric generator, so as to meet the power required for starting the electric generator.

15. The start-up battery module according to claim 14, wherein the Li-ion battery comprising lithium iron phosphate (LiFePO₄).

16. The start-up battery module according to claim 14, wherein the Li-ion battery comprising Li(Ni_{0.5}Mn_{0.5})₁₋ₓCoₓO₂, 1≧x≧0.

17. The start-up battery module set according to claim 14, wherein the Li-ion battery comprising Li(MnₓCo₁₋ₓ)O₂, 1≧x≧0.

18. The start-up battery module set according to claim 14, wherein the Li-ion battery consist of Li-beta spinal Mn₂O₄.

19. The start-up battery module according to claim 14, wherein the start-up battery module further comprises at least one protection circuit module, serially-connected to the Li-ion battery to form a series group, so as to prevent the Li-ion battery from being damaged.

20. The start-up battery module according to claim 14, wherein the super capacitor reflects a pulse rise time less than 5 microseconds to meet the power required for starting the electric generator.

21. The start-up battery module according to claim 14, wherein the super capacitor is at least one metal-ceramic ruthenium-oxide super capacitor.

22. The start-up battery module according to claim 14, wherein the super capacitor is at least one platinum-based super capacitor.

23. The start-up battery module according to claim 14, wherein the super capacitor is at least one gold-based super capacitor.
